(19) United States
(12) Patent Application Publication
(10) Pub. No.: US 2008/0087528 A1
(43) Pub. Date: Apr. 17, 2008

(54) Rotary encoder switch

(76) Inventors: Konstantinos Michailidis, Glienicke (DE); Andreas Pancke, Berlin (DE)

Correspondence Address: HARNESS, DICKEY & PIERCE, P.L.C., P.O.BOX 8910, RESTON, VA, 20195, US

(21) Appl. No.: 11/905,248

(22) Filed: Sep. 28, 2007

Related U.S. Application Data
(63) Continuation-in-part of application No. PCT/EP2006/060542, filed on Mar. 8, 2006.

(30) Foreign Application Priority Data
Mar. 31, 2005 (DE) 10 2005 015 499.9

(51) Int. Cl. H01H 19/00

(52) U.S. Cl. 200/11 D

(57) ABSTRACT

A rotary encoder switch includes a plurality of switch positions for parameter setting, in particular for low-voltage circuit breakers, in the form of a binary code, having two rotary switch elements, which interact with one another and of which one is designed to set the desired switch position with respect to the other by being able to rotate in steps about a fixed axis, with the first switch position following immediately again after one complete revolution the last switch position, having a plurality of switches which are formed by the one rotary switch element and by fixed-arranged contacts, and of which at least one is opened or at least one is closed when changing from one switch position to the next. A plurality of outputs are included, via which a binary signal, in particular a voltage signal, is in each case output as a function of whether the switch is closed or open in the respective switch position, with the binary signals from all of the outputs together forming the binary code. In at least one embodiment, in order to ensure that only one of the values of the respectively adjacent switch positions can be output in each case in an intermediate switch position, at least one switch is in the closed switching state in each switch position, and only the switching state of a single switch in each case changes whenever switching takes place from one switch position to the next, including switching from the last switch position to the first switch position.

### PRIORITY STATEMENT

This application is a continuation in part application of PCT International Application No. PCT/EP2006/060542, which has an International filing date of Mar. 8, 2006, the entire contents of which is hereby incorporated herein by reference. This application further claims priority of PCT International Application No. PCT/EP2006/060542 which has an International filing date of Mar. 8, 2006, which designated the United States of America and which claims priority on German Patent Application number DE 10 2005 015 499.9 filed Mar. 31, 2005, the entire contents of each of which is hereby incorporated herein by reference.

### FIELD

At least one embodiment of the invention generally relates to a rotary encoder switch, such as one having a plurality of switching steps for parameter setting for an overcurrent release for low-voltage circuit breakers for example. The parameters may be set, in one embodiment for example, to define a tripping characteristic for the delayed overcurrent tripping.

### BACKGROUND

If a binary code corresponding to the positions 0 to 9 is used for coding (hexadecimal code, hexadecimal code complementary, BCD code, BCD code complementary), then, in U.S. Pat. No. 4,559,419 A by way of example, a plurality of “bits” may change when changing from one switch position or switching step to the next, that is to say a plurality of switches change their switching from closed to open and/or vice versa. During the transition between two switch positions, setting values can therefore occur which do not correspond to either of the two switch positions. Incorrect assessment of the position can then influence the behavior of the overcurrent release in an undesirable manner, leading to spurious tripping.

In order to very largely avoid such undesirable intermediate positions, special codes have already been used which ensure that only one bit changes in each case between the switch positions 0 and 9, that is to say the switching state of only a single switch. An incorrect position can then relate only to the higher or the lower of two adjacent switch positions, so that the error remains low. One such coding is known as the Gray code or a corresponding complementary coding (0 and 1 are interchanged).

U.S. Pat. No. 6,067,218 A (EP 0 693 812 A1) has already disclosed the use of a Gray code such as this for setting parameters for the overcurrent release of a circuit breaker. The disadvantage of this coding is that three switches have to change their state when changing from 9 to 0, allowing a large number of assessments. Correct evaluation of the switch position is therefore no longer ensured.

Some manufacturers prefer mechanical locking of the zero position, which prevents this fault. One disadvantage in this case is, however, the loss of one switch position.

Furthermore, in known coding systems, there is one switch position with the binary coding “0000”. This coding at the same time corresponds to the absence of a rotary encoder switch or to an open fixed contact (root contact). Error sources also occur here.

### SUMMARY

At least one embodiment of the invention is directed to a rotary encoder switch which is not subject to at least one of the disadvantages described above and in which a switch intermediate position can assume only one of the values of the immediately adjacent switch positions for all switching movements.

In at least one embodiment, a solution provides for at least one switch to be in the closed switching state for each switch position, and for, in each case, only the switching state of a single switch can change whenever switching takes place from one switch position to the next, including the situation in which switching takes place from the last switch position to the first switch position. In addition to avoiding errors in the event of undefined intermediate positions between the switch positions 0 and 9, the coding method according to at least one embodiment of the invention also ensures that only one contact position is changed, as well, on rotation beyond 9 to 0.

In order additionally to avoid the error resulting from the ambiguity of the coding “0000”, the coding is chosen differently from previously known coding systems by at least one contact being closed in each switch position. The coding “0000” can therefore be used to check for the presence of a rotary encoder switch. The tripping unit can then be operated with standard software irrespective of the number of rotary encoder switches there are in a low-voltage circuit breaker. The software then cyclically checks which of the rotary encoding switches are in fact present and can therefore, for example, distinguish between a switch with and one without earth-fault detection.

Furthermore, the software can determine whether a rotary encoder switch is faulty if a coding “00001” is signaled for a rotary encoder switch which must be present

### BRIEF DESCRIPTION OF THE DRAWINGS

FIGS. 1-3 illustrate one example embodiment of a disassembled rotary encoder switch with a plurality of switch positions for parameter setting for a low-voltage circuit breaker, which is not shown in any more detail, with the parameters being set in the form of a binary code.

FIG. 4 shows one example of a table of a coding system according to an embodiment of the invention.

### DETAILED DESCRIPTION OF THE EXAMPLE EMBODIMENTS

In an example embodiment, the rotary encoder switch has a housing 1 with a central cylindrical opening, which has been looked in obliquely from above in FIG. 3. Five electrical contacts (metal contact 2) are located on the base of this opening, are arranged in a fixed form and are each connected to one of the pins 3 which pass to the outside. Only the lower three of the pins 3 can be seen in FIG. 3, while the upper pins are concealed by the housing 1.

A rotary switch element 6 with a total of five finger-like sprung switching contacts 7 is located in the cylindrical opening in the housing 1. A rotary switch element 4 which interacts with this and has radial projections 5 is inserted into the housing 1 above this, such that it can rotate. The projections 5 press each of the switching contacts 7 which are located immediately underneath them against the metal contact 2, and in this way close the switches formed from the switching contacts 7 and the metal contacts 2.

The rotary switch element 4 is in the form of a disk and can rotate in steps about a fixed axis. A total of ten switch positions are provided here. The last (tenth) switch position after one complete revolution is once again immediately followed by the first switch position again.

The lengths, arrangements with respect to one another and radial distance between (with respect to the rotation axis) of the projections 5 are chosen such that at least one switch is in the closed switching state in each switch position, and such whenever switching takes place from one switch position to the next, including switching from the last switch position to the first switch position, only the switching state of a single switch ever changes. Only one of the finger-like switching contacts 7 is therefore in each case moved downwards towards the immediately opposite metal contact 2, or else away from it. During a transition from one switch position to the next, one and only one switch is ever open, or else one switch is closed in each case only the switching state of a single switch therefore ever changes.

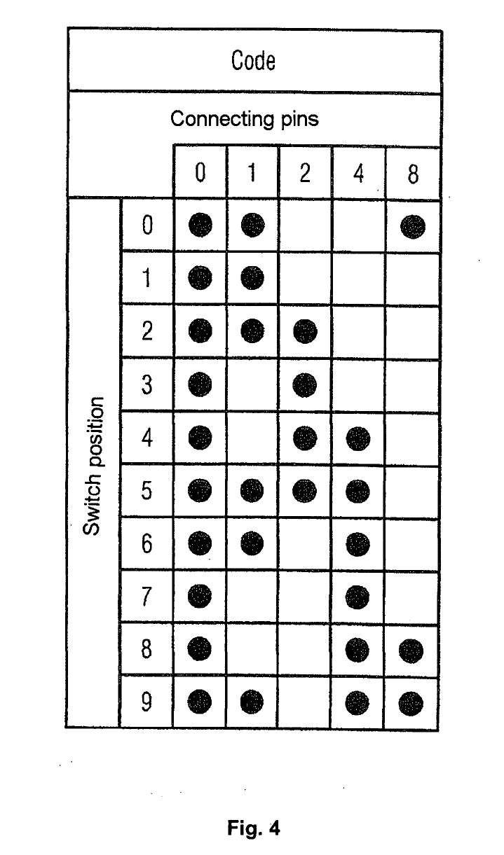

A predetermined voltage is applied to the central pin 3 at the bottom (the input pin) in FIG. 3 and is passed to the other five pins 3 (the outputs of the connecting pins 0, 1, 2, 3, 4, 8 in the table of FIG. 4) by way of the switches with the switching contacts 7. Depending on whether the switches are closed or open in the respective switch position, a binary voltage signal is in each case output via the five pins 3, with the binary signals of all five output pins (pins 3) in each case jointly forming the binary code.

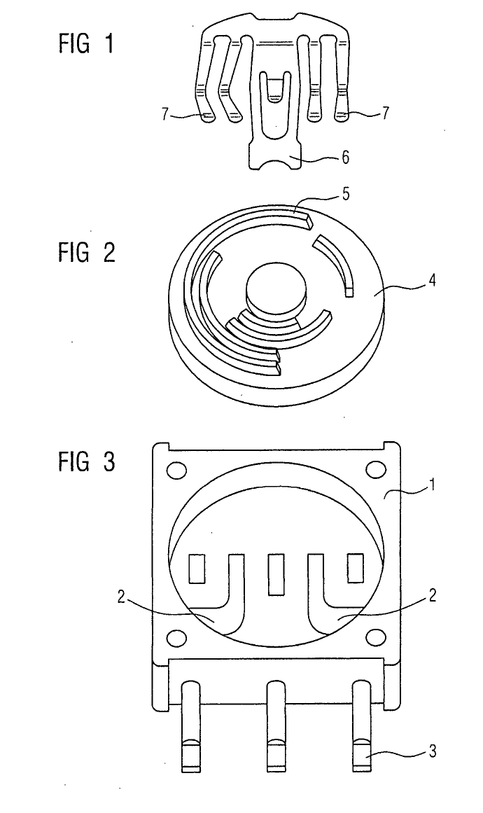

The table of FIG. 4 shows one example of a coding system according to an embodiment of the invention, which in this case is produced by the rotary encoder switch as shown in FIGS. 1-3. The connecting pin 0 is formed by the central metal contact 2 (fixed contact or root contact), which is connected to the central pin 3, at the bottom in FIG. 3. The other four metal contacts 2 are connected to the other pins 3, and therefore form the connecting pins 1, 2, 4 and 8 in the table.

The switch positions 1 to 9 correspond to the following binary numbers shown in table 1:

TABLE 1

| Switch position | Binary Number |
|---|---|
| 1 = | 1 |
| 2 = | 3 |
| 3 = | 2 |
| 4 = | 6 |
| 5 = | 7 |
| 6 = | 5 |
| 7 = | 4 |
| 8 = | 12 |
| 9 = | 13 |

As can be seen from the table of FIG. 4, this coding system ensures that only one “bit” ever changes when changing from one switch position to the next, or to the previous switch position. That is to say there is only one contact change and, in contrast to the previously used coding systems, the switch position 0 does not correspond to a binary 0, but to a binary 9, so that only one bit likewise changes when changing from the switch position 9 to the switch position 0 and, furthermore, the constellation “0000”, which would also occur in the event of a missing or faulty rotary encoder switch, is avoided.

In addition to the coding shown in the table of FIG. 4, a complementary coding system (0 and 1 are interchanged) is, for example, also possible. A coding system such as this would also satisfy the conditions—missing 0, change by only one bit to the next switch position.

Other 4-bit coding systems are feasible which satisfy the required conditions.

In at least one other embodiment, a rotary encoder switch, including a fixed contact and contacts connectable to the fixed contact by sliding contacts, in four contact rows, with a number of the contacts connected to the fixed contact corresponding to a coding of the digits 0 to 9, includes a coding system in which at least one contact in one contact row is closed in each switch position, and whenever a switch position changes from one position into a next position, only one contact position changes.

In at least one embodiment, the at least one contact in one contact row closed in each switch position, may be connected to the fixed contact. Further, the switch position changing from one position into a next position may include when the switch position changes from 9 to the switch position 0.

In at least one embodiment, the coding of the rotary encoder switch corresponds to the table of FIG. 4.

In at least one embodiment, the coding of the rotary encoder switch is complementary to the table of FIG. 4.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A rotary encoder switch, comprising:
a plurality of switch positions, for parameter setting in the form of a binary code, including two rotary switch elements to interact with one another, one rotary switch element being designed to set a desired switch position with respect to the other rotary switch element by being rotatable in steps about a fixed axis, the first switch position following immediately again after one complete revolution of the last switch position; and
a plurality of switches, formed by the one rotary switch element and by fixed-arranged contacts, of which at least one is opened or at least one is closed when changing from one switch position to the next;
a plurality of outputs, via each of which a binary signal is output as a function of whether the switch is closed or open in the respective switch position, the binary signals from all of the outputs together forming the binary code, wherein at least one switch is in the closed switching state in each switch position, and wherein only the switching state of a single switch in each case changes whenever switching takes place from one switch position to the next, including switching from the last switch position to the first switch position.

2. The rotary encoder switch as claimed in claim 1, wherein the coding corresponds to the table of FIG. 4.

3. The rotary encoder switch as claimed in claim 1, wherein the coding which is complementary to the table of FIG. 4.

4. The rotary encoder switch as claimed in claim 1, wherein the plurality of switch positions for parameter setting are for low-voltage circuit breakers.

5. The rotary encoder switch as claimed in claim 1, wherein the binary signal is a voltage signal.

6. The rotary encoder switch as claimed in claim 2, wherein the plurality of switch positions for parameter setting are for low-voltage circuit breakers.

7. The rotary encoder switch as claimed in claim 2, wherein the binary signal is a voltage signal.

8. The rotary encoder switch as claimed in claim 3, wherein the plurality of switch positions for parameter setting are for low-voltage circuit breakers.

9. The rotary encoder switch as claimed in claim 3, wherein the binary signal is a voltage signal.

10. A rotary encoder switch including a fixed contact and contacts connectable to the fixed contact by sliding contacts, in four contact rows, with a number of the contacts connected to the fixed contact corresponding to a coding of the digits 0 to 9, the rotary encoder switch comprising:
a coding system in which at least one contact in one contact row is closed in each switch position, and whenever a switch position changes from one position into a next position, only one contact position changes.

11. The rotary encoder switch as claimed in claim 10, wherein the at least one contact in one contact row closed in each switch position, is connected to the fixed contact.

12. The rotary encoder switch as claimed in claim 10, wherein the switch position changing from one position into a next position includes when the switch position changes from 9 to the switch position 0.

13. The rotary encoder switch as claimed in claim 10, wherein the coding corresponds to the table of FIG. 4.

14. The rotary encoder switch as claimed in claim 10, wherein the coding which is complementary to the table of FIG. 4.
